(19) United States
(12) Patent Application Publication
(10) Pub. No.: US 2015/0223278 A1
(43) Pub. Date: Aug. 6, 2015

(54) System and Method for Establishing a Wireless Connection

(71) Applicants: Mary Reaston, Tulsa, OK (US); Phil Reaston, Tulsa, OK (US)

(72) Inventors: Mary Reaston, Tulsa, OK (US); Phil Reaston, Tulsa, OK (US)

(21) Appl. No.: 14/171,373

(22) Filed: Feb. 3, 2014

(51) Int. Cl. H04W 76/02; H04W 8/00; H04W 4/00

(52) U.S. Cl. CPC H04W 76/023; H04W 4/008; H04W 8/005

(57) ABSTRACT

A system and method for establishing a wireless connection that functions in combination with a first wireless-enabled device and at least one second wireless-enabled device. The devices can include a desktop computer, a laptop computer, a tablet computer, a smartphone, a cell phone, a printer or a camera The system and method functions with a conventional wireless communication protocol such as BLUETOOTH®, ZipBee or WiFi. A proprietary software program facilitates the first device identifying and establishing a wireless connection with the at least one second device, without the use of conventional pairing functionality.

### TECHNICAL FIELD

The invention generally pertains to wireless communication, and more particularly to system for establishing a wireless data connection between wireless enabled devices.

### BACKGROUND ART

In the Twenty-first century wireless connectivity has advanced to the stage of being the preferred method of connection for many of the most widely used electronic devices. The most ubiquitous wireless connections today are utilized for telephones and computers, although other devices such as medical diagnostic devices also benefit from wireless connectivity.

Currently, there are three predominant types of wireless connections: BLUETOOTH®,

ZigBee and WiFi. Using BLUETOOTH®, a connection protocol known as pairing can be performed to establish a wireless connection. Wireless pairing does have inherent problems and limitations. Pairing is often time consuming as it requires wireless devices to be pre-paired before use. Pairing may also present a security risk since it is possible for a person to insert a non-authorized or unwanted device into the wireless connection.

What is needed is more technologically advanced wireless connection that does not require pairing. An advanced wireless connection would be easier and faster to use, could provide a secure connection and could provide increased functionally such as allowing the concurrent use of multiple wireless devices and the ability to switch out devices while maintaining the wireless connection.

A search of the prior art did not disclose any literature or patents that read directly on the claims of the instant invention. However, the following U.S. patents are considered related:

| PAT. NO. | INVENTOR | ISSUED |
|---|---|---|
| 7,706,794 | Young | Apr. 27, 2010 |
| 7,912,017 | Horisawa | Mar. 22, 2011 |
| 8,295,769 | Bloebaum | Oct. 23, 2012 |
| 8,489,082 | Kaisha | Jul. 16, 2013 |

The U.S. Pat. No. 7,706,794 patent discloses a method for connecting personalized devices through a wireless link. In the method, wireless connection information of a plurality of coordinator devices connected to a personalized device through a wireless link is stored. A channel is then set to receive the connection information which is received from a coordinator device through a set channel. If the coordinator device transmitting the connection information is the coordinator to connect, the coordinator device is connected. If not, a coordinator device having the next highest priority is utilized.

The U.S. Pat. No. 7,912,017 patent discloses wireless connection system having at least one host apparatus and at least one client apparatus. Wireless communication is executed when a host apparatus and a client apparatus execute wireless communication with each other on the basis of a predetermined wireless communication standard. An authentication process is executed for authenticating the connection setting information. If authentication is successful, execution of the wireless communication is enabled.

The U.S. Pat. No. 8,295,769 patent discloses a method and a system for wirelessly connecting two data devices. A user intending to connect the devices issues a connect activation command and then moves one device toward the other device along a connection vector. A wireless communication connection is established through Ultra Wideband (UWB) protocol when the two devices are in range of each other.

The U.S. Pat. No. 8,489,082 patent discloses a computer program product that comprises computer readable instructions that cause a computer to be wirelessly connectable with at least one device to execute a wireless connection setting process. The wireless connection setting process establishes a wireless connection with the at least one device, transmits externally inputted settings of the wireless connection to the at least one device, and configures the same settings as the settings transmitted to the at least one device.

The 2008000210769 publication application discloses a method and a system for wirelessly connecting two data devices. A user intending to connect the devices issues a connect activation command and then moves one device toward the other device along a connection vector. A wireless communication connection is established through. Ultra Wideband (UWB) protocol when the two devices are in range of each other.

For background purposes and indicative of the art to which the invention relates, reference may be made to the following remaining patents found in the patent search.

| PAT. NO. | INVENTOR | ISSUED |
|---|---|---|
| 8,588,769 | Saitou | Nov. 19, 2013 |
| 8,295,223 | Hua | Oct. 23, 2012 |
| 7,593,954 | Inagaki | Sep. 1, 2009 |

### DISCLOSURE OF THE INVENTION

In its most basic design, the system for establishing a wireless connection functions in combination with a first wireless enabled device and at least one second wireless enabled device. The system functions with a conventional wireless communication protocol with as BLUETOOTH®, Zigbee or Wild, and utilizes a software program that facilitates the first wireless enabled device identifying and establishing a wireless connection with the at least one second wireless device. The system allows a direct connection that does not require a pre-connection discovery function and can provide a more secure connection than other conventional connection methods.

in view of the above disclosure, the primary object of the invention is to provide a system for establishing a wireless connection that does not require a pairing function which is utilized by some wireless communication methods.

In addition to the primary object of the invention, it is also an object of the invention to provide a system for establishing a wireless connection that:
is easy to use,
can be utilized with various wireless communication methods
allows interchangeability of wireless devices,
can be used with medical devices that require multiple wireless transmission means,
requires less set-up time than other conventional wireless systems,
when used with wireless sensors, allows quick and easy replacement of the sensors,
allows a direct connection with a MAC address,
does not require pre-connection discovery, thereby improving the performance of the wireless connectivity,
is economical and cost-effective to implement, and
is cost effective from both a manufacturer's and consumer's point of view.

These and other objects and advantages of the present invention will become apparent from the sub sequent detailed description of the preferred embodiment and the appended claims taken in conjunction with the accompanying drawings.

### BRIEF DESCRIPTION OF THE DRAWINGS

FIG. 1 is a flow diagram showing the steps that are performed in the method.

### BEST MODE FOR CARRYING OUT THE INVENTION

The best mode for carrying out the invention is presented in terms that disclose a preferred embodiment of a system and method for establishing a wireless connection. Current conventional wireless connection means are accomplished by the use of technology that has remained substantially the same as when it was initially developed. A predominant function of conventional wireless connectivity is known as pairing, which is utilized by the BLUETOOTH® method of wireless data transmission. Pairing requires a strict protocol for establishing a wireless connection, and has inherent limitations on the functionality of the wireless connection.

The instant system and method for establishing a wireless connection (hereinafter “system and method”), allows the use of current wireless data transmission protocols such as BLUETOOTH®, as well as others including ZigBee and WiFi, without the requirement of pairing.

The system and method can be utilized with any device that allows wireless connectivity. These devices include, but are not limited to: a desktop computer, a laptop computer, a tablet computer, a smartphone, a cell phone, a printer or a camera. For this disclosure a medical diagnostic unit, which is known as an Electrodiagnostic Functional Assessment Device (EFA), will be described. The EFA is typically comprised of a computer running a proprietary software program and at least one wireless sensor that is attached to a selected location on a person's body. It should be noted that in most typical medical assessments, multiple wireless sensors are utilized. The software program facilitates the EFA identifying and establishing a wireless connection with the at least one wireless sensor.

As previously disclosed, the identification and establishment of the wireless connection is accomplished without the use of pairing. Since pairing is not utilized, any type of pre-pairing is also not required.

The instant system and method utilizes the proprietary software program to provide the necessary commands that cause the wireless connection to be established. The software program instructs the EFA to identify each wireless sensor and, once identification has been conformed, to then establish each wireless connection. The identification and establishment of the wireless connection is accomplished by use of a barcode scanner that is interfaced with the EFA and which is utilized to scan each wireless sensor. The scanned sensor data is then used by EFA software program to facilitate the bi-directional wireless connection.

The EFA and each wireless sensor can he connected via a radio connection or a wired access point. Again, since conventional pairing is not utilized, the instant wireless connection is directly accomplished without the use of a pre-connection discovery function.

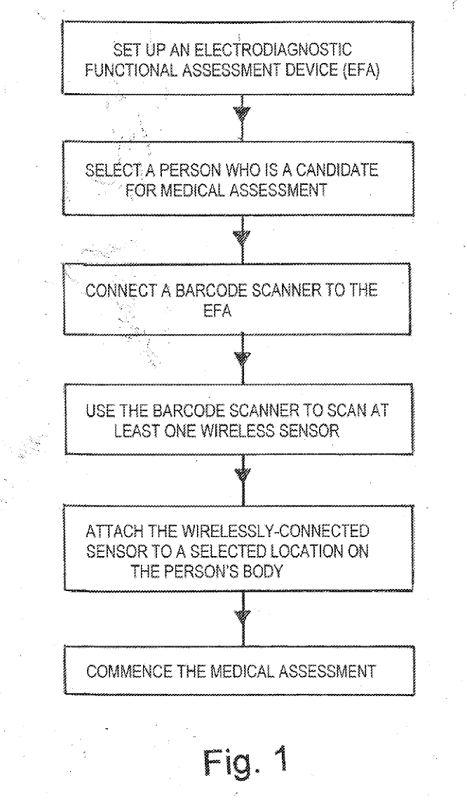

The method portion of the instant system and method, as shown in FIG. 1, is accomplished by performing the following steps:

1. Set up an Electrodiagnostic Functional. Assessment Device (EFA).

2. Select a person who is a candidate for medical assessment.

3. Connect a barcode scanner to the EFA.

4. Use the barcode scanner to scan at least one wireless sensor, which allows the EFA software to identify the scanned sensor and to establish a bi-directional wireless connection between the EFA and the sensor.

5. Attach the wirelessly-connected sensor to a selected location on the person's body.

6. Commence the medical assessment.

The instant system and method provides significant improvement over conventional pairing connections. The instant system and method is easier to use and requires less time to set up, can provide a higher level of security, and can even allow, for example when using the EFA with wireless sensors, a wirelessly-connected sensor to be removed and replaced with another wireless sensor while maintaining the wireless connection.

While the invention has been described in detail and pictorially shown in the accompanying drawings it is not to be limited to such details, since many changes and modification may be made to the invention without departing from the spirit and the scope thereof. Hence, it is described to cover any and all modifications and forms which may come within the language and scope of the claims.

1. A system and method for establishing a wireless connection that functions in combination with a first wireless-enabled device and at least one second wireless-enabled device, wherein a software program facilitates the first wireless-enabled device to identify and establish a wireless connection with the second wireless-enabled device.

2. The system and method as specified in claim 1 wherein said software facilitated identification and connection between the first and at least one second wireless devices replaces a conventional pairing connection of two wireless devices.

3. The system and method as specified in claim 1 wherein the first and at least one second wireless devices utilize a wireless communication protocol that is selected from the group consisting of BLUETOOTH®, ZigBee and WiFi.

4. The system and method as specified in claim 1 wherein the first and at least one second wireless device are selected from the group consisting of a desktop computer, a laptop computer, a tablet computer, a smartphone, a printer, a cell phone, and a camera.

5. The system and method as specified in claim 1 wherein when multiple second wireless devices are utilized, each device's wireless connection functions independently.

6. The system and method as specified in claim 1 wherein multiple second wireless devices concurrently receive data.

7. The system and method as specified in claim 1 wherein the at least one second wireless device is removed and replaced with another wireless device that maintains the wireless connection.

8. A system and method for establishing a wireless connection that functions in combination with a wireless enabled medical diagnostic device incorporating a wireless communication protocol and a software program, and at least one wireless sensor, wherein the software program facilitates the medical diagnostic device identifying and establishing a wireless connection with the at least one sensor.

9. The system and method as specified in claim 8 wherein the medical diagnostic device is comprised of an Electrodiagnostic Functional Assessment Device (EFA).

10. The system and method as specified in claim 9 wherein said software facilitates identification and connection between said EFA and at least one sensor replaces a conventional pairing connection of two wireless devices.

11. The system and method as specified in claim 8 wherein the wireless communication protocol is selected from the group consisting of BLUETOOTH®, ZigBee and WiFi.

12. The system and method as specified in claim 8 wherein a barcode scanner is utilized to scan the at least one wireless sensor, wherein the barcode scan functions as the catalyst for the identifying and establishing the wireless connection.

13. The system and method as specified in claim 8 wherein the at least one wireless sensor is attached to a selected location on a person's body.

14. The system and method as specified in claim 8 wherein when multiple wireless sensors are utilized, each sensor's wireless connection functions independently.

15. The system and method as specified in claim 8 wherein the at least one wireless sensor is removed and replaced with another wireless sensor that maintains the wireless connection.

16. The system and method as specified in claim 9 wherein said EFA and at least one wireless sensor are wirelessly connected via a radio connection or a wired access point.

17. The system and method as specified in claim 8 wherein said software facilitated wireless connection is directly accomplished without the use of a pre-connection discovery function required.

18. The system and method as specified in claim 8 wherein said software facilitated wireless connection provides increased security capability over a conventional pairing connection of two wireless devices.

19. A method and method for establishing a wireless connection between an electrodiagnostic functional assessment device (EFA) running a software program and at last one wireless sensor that is attached to a selected location on a person's body, wherein said software program facilitates said EFA identifying and establishing a wireless connection with the at least one wireless sensor, wherein said software facilitated identification and connection replaces a conventional pairing connection of two wireless devices, wherein the at least one sensor provides to said EFA physiological data from the person's body and quantitative quality of service data including packet: loss and sensor connection data, wherein said system allows a direct connection without pre-connection discovery and provides a more secure connection over a conventional pairing connection, wherein to utilize said method the following steps are performed:
a) set up an Electrodiagnostic Functional Assessment Device (EFA),
b) select a person who is a candidate for medical assessment,
c connect a barcode scanner to the EFA,
d) use the barcode scanner to scan at least one wireless sensor, which causes the EFA software to identify the sensor and to establish a bi-directional wireless connection between the EFA and the sensor,
e) attach the wirelessly-connected sensor to a selected location on the person's body, and
f) commence the medical assessment.

20. The system and method as specified in claim 19 wherein the barcode scanner that is utilized to scan the at least one wireless sensor functions as the catalyst for the identifying and establishing the wireless connection.
